(19) United States
(12) Patent Application Publication
(10) Pub. No.: US 2019/0293239 A1
(43) Pub. Date: Sep. 26, 2019

(54) FLUID SUPPLY DEVICE

(71) Applicant: L'Air Liquide, Société Anonyme pour I'Etude et I'Exploitation des Procédés Georges Claude, Paris (FR)

(72) Inventors: Antoine FRENAL, Ezanville (FR); Léna QUEAU, Andresy (FR); Olivier ONDO, Palaiseau (FR); Renaud LIGONESCHE, Herblay (FR); David LAURENT, Le Perray en Yvelines (FR)

(21) Appl. No.: 16/318,909

(22) PCT Filed: Jun. 20, 2017
(86) PCT No.: PCT/FR2017/051628

§ 371 Date: Jan. 18, 2019

(30) Foreign Application Priority Data
Jul. 20, 2016 (FR) 1656903

(51) Int. Cl. F17C 13/04

(52) U.S. Cl. CPC F17C 13/04; F17C 2205/0326; F17C 2205/058; F17C 2223/0123; F17C 2250/032; F17C 2250/0636; F17C 2250/0443; F17C 2250/0439; F17C 2205/0338; F17C 2250/043; F17C 2250/0447; F17C 2250/034

(57) ABSTRACT

A fluid supply device including a pressurized fluid valve, including a body, a fluid circuit accommodated at least in part in the body, the fluid circuit having an upstream end configured to be connected to a reserve of pressurized fluid and a downstream end configured to be connected to a receiving device, the fluid circuit including at least one member for controlling the flow rate in the fluid circuit and a member for actuating the fluid circuit, the at least one control member including an adjustable flow rate regulator, controlled by a data acquisition and processing electronic unit integrated into the valve and including an antenna or a wired connection configured to receive a remote control signal from the flow rate regulator to monitor and to control remotely the flow rate imposed by the flow rate regulator.

### CROSS REFERENCE TO RELATED APPLICATIONS

This application is a 371 of International PCT Application PCT/FR2017/051628, filed Jun. 20, 2017, which claims priority to French patent Application 1656903, filed Jul. 20, 2016, the entire contents of which are incorporated herein by reference.

### BACKGROUND

The invention concerns a fluid supply device.

The invention more particularly concerns a fluid supply device including a pressurized fluid valve, with or without an integrated pressure-reducing valve, including a body, a fluid circuit accommodated at least in part in the body, the circuit having an upstream end intended to be connected to a reserve of pressurized fluid and a downstream end intended to be connected to a receiving device, the circuit including at least one member for controlling the flow rate in the circuit and a member for actuating the latter.

To improve the functionalities of a valve for pressurized fluid bottle(s) it is known to provide units for monitoring the fluid. See for example the documents EP2663793A, EP2674660A or US20050126571A.

These units are adapted to cooperate with a pressurized fluid valve to adapt the functionalities of the valve.

Adapting the flow rate monitoring functionalities necessitates the provision of modular elements that satisfy requirements in terms of reliability, safety and correct operation.

### SUMMARY

An object of the present invention is to improve on the prior art referred to above or to alleviate some or all of the disadvantages thereof.

To this end, the fluid supply device according to the invention, otherwise conforming to the generic definition thereof given in the above preamble, is essentially characterized in that the at least one control member includes an adjustable flow rate regulator, controlled by a data acquisition and processing electronic unit integrated into the valve and including an antenna or a wired connection configured to receive a remote control signal from the flow rate regulator to monitor and to control remotely the flow rate imposed by the latter.

Moreover, embodiments of the invention may include one or more of the following features:
the device includes a unit for determining the nature of the fluid in the circuit connected to the data acquisition and processing electronic unit, the electronic unit being configured to adapt how the flow rate regulator is controlled as a function of the nature of the fluid, that is to say to adjust or to calibrate the flow rate regulator as a function of said nature of the fluid,
the flow rate regulator includes a mechanism for modifying the size of at least one passage for the fluid to modify its flow rate, the data acquisition and processing electronic unit being configured to store and/or to receive a set of calibration data, notably curves or equations, defining respective sizes of the at least one passage as a function of the nature of the fluid in the flow regulator to obtain a particular flow rate,
the unit for determining the nature of the fluid includes a wireless scanning electronic device such as a transponder configured for wireless remote scanning of information stored by a data storage electronic device such as a wireless communication RF tag attached to a fluid source,
the device includes at least one of the following: a pressure sensor configured to measure the pressure in the circuit on the upstream side of the flow rate regulator, a pressure sensor configured to measure the pressure in the circuit on the downstream side of the flow rate regulator, a sensor of the temperature in the circuit, a flow rate sensor, the data acquisition and processing electronic unit of the valve being configured to determine or to calculate the value of the fluid flow rate in the circuit on the basis of the information from the aforementioned at least one sensor,
the device includes a hand portable data acquisition, storage and processing electronic device such as a remote control including a wireless communication device and at least one display, said device being configured to exchange data with the data acquisition and processing electronic unit of the valve remotely to monitor, display and control information, notably the flow rate imposed by the flow rate regulator,
the electronic device includes a human-machine interface configured to display tactile control symbols for modifying the flow rate value imposed by the flow rate regulator,
the valve includes a pressure-reducing valve situated in the circuit on the upstream side of the flow rate regulator and configured to reduce the pressure of the fluid to a particular fixed or variable value, the valve including at least one pressure sensor configured to measure the pressure in the circuit on the upstream side of the flow rate regulator on the upstream and/or downstream side of the pressure-reducing valve, the data acquisition and processing electronic unit being configured to receive the measurements from the at least one pressure sensor and automatically to adjust accordingly the flow rate imposed by the flow rate regulator as a function of any fluctuation of the measured pressure,
the data acquisition and processing electronic device is configured to receive the measurements from at least one temperature sensor in the circuit and to calculate the fluid flow rate in the circuit as a function of the temperature measurement, the pressure measurement and the configuration of the flow rate regulator using a gas state equation such as a perfect gas state equation,
the data acquisition and processing electronic unit is configured to receive the measurements from at least one flow rate sensor in the circuit on the downstream side of the flow rate regulator, the data acquisition and processing electronic unit being configured, in response, to carry out at least one of the following: sending the measured flow rate value to the portable data acquisition, storage and processing electronic device in order to display it, automatically adjusting the flow rate imposed by the flow rate regulator as a function of any difference between the measured flow rate and the imposed flow rate,
the flow rate regulator includes a variable orifice mechanism of piezoelectric type and/or of rotary or sliding valve type, notably a slide valve,
the upstream end of the body of the valve is fluidically connected to a tank or to a set of tanks of pressurized gas including a data storage electronic device that can be interrogated remotely such as a wireless communication RF tag, the data storage electronic device storing information defining the nature of the gas in the tank or tanks, the fluid supply device including an electronic device for remotely scanning information stored in the data storage electronic device configured to transfer said information to the data acquisition and processing electronic unit integrated into the valve,
the flow rate regulator is accommodated in a regulator module removably mounted in a housing formed on the body of the valve,
the data acquisition and processing electronic unit is at least partially accommodated in the regulator module,
the valve includes at least one first functional electronic unit intended to exchange data with an electronic unit of the regulator module, the body of the valve including a device with contact(s) situated in the housing intended to cooperate with a conjugate set of electrical contact(s) situated on the regulator module when the latter is in the position mounted on the body of the valve,
the valve can be fluidically connected to another, so-called “base valve” valve possibly attached to at least one pressurized fluid bottle, the valve comprising a mobile member (such as a valve pusher) the movement of which is controlled by the actuator member to command the opening or the closing of a valve for isolating the base valve to which said valve is removably connected,
the actuator member includes at least one of the following: a rotary wheel, a pushbutton, a lever pivoting on the body,
the size of the variable orifice can be measured to determine the flow rate allowed to pass through it (for example via a potentiometer, angle sensor, travel sensor, etc.), and this measurement may in particular replicate a commanded position,
when the regulator module is in position mounted on the body of the valve, the actuator member is mobile between a first position in which said actuator member does not impede the movement of the second functional electronic unit relative to the body of the valve allowing it to be detached from the body and a second position in which the actuator member forms a mechanical abutment hindering movement of the regulator module relative to the body to prevent demounting it from the body.

The invention may equally concern a pressurized fluid bottle or set of bottles (rack) including a device of the above kind.

The invention may equally concern any alternative device or method including any combination of the above or following features.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 represents a diagrammatic and partial perspective view illustrating one embodiment of a valve in accordance with the invention in a demounted position,

FIG. 2 represents a diagrammatic and partial perspective view from below illustrating one embodiment of one example of a regulator module intended to be associated with the valve from FIG. 1,

FIG. 3 represents a diagrammatic and partial side view respectively illustrating another embodiment of regulator modules that may be associated with the valve from FIG. 1,

FIG. 4 represents a diagrammatic and partial side view illustrating another embodiment of regulator modules that may be associated with the valve from FIG. 1,

FIG. 5 represents a diagrammatic and partial side view illustrating another embodiment of a valve in accordance with respective distinct configurations (respectively mounted and demounted),

FIG. 6 represents a diagrammatic and partial side view illustrating another embodiment of a valve in accordance with respective distinct configurations (respectively mounted and demounted),

FIG. 7 represents a diagrammatic and partial side view illustrating another embodiment of a valve in accordance with the invention,

FIG. 8 represents a diagrammatic and partial side view illustrating another embodiment of a valve in accordance with the invention,

FIG. 9 represents a diagrammatic and partial side view illustrating another embodiment of a regulator module for taps in accordance with the invention,

FIG. 10 represents a diagrammatic and partial side view illustrating an embodiment and an example of use of a device in accordance with the invention,

FIG. 11 represents a diagrammatic view illustrating respective regulated flow rate curves obtained with identical setpoints applied to two different types of gas,

FIG. 12 represents a diagrammatic and partial perspective view of a detail of a valve in accordance with another possible embodiment,

FIG. 13 represents a diagrammatic and partial perspective view from below illustrating another embodiment of an example of a regulator module that may be associated with the valve.

### DESCRIPTION OF PREFERRED EMBODIMENTS

The fluid supply device illustrated in the figures includes a pressurized fluid valve 1 with or without an integrated pressure-reducing valve.

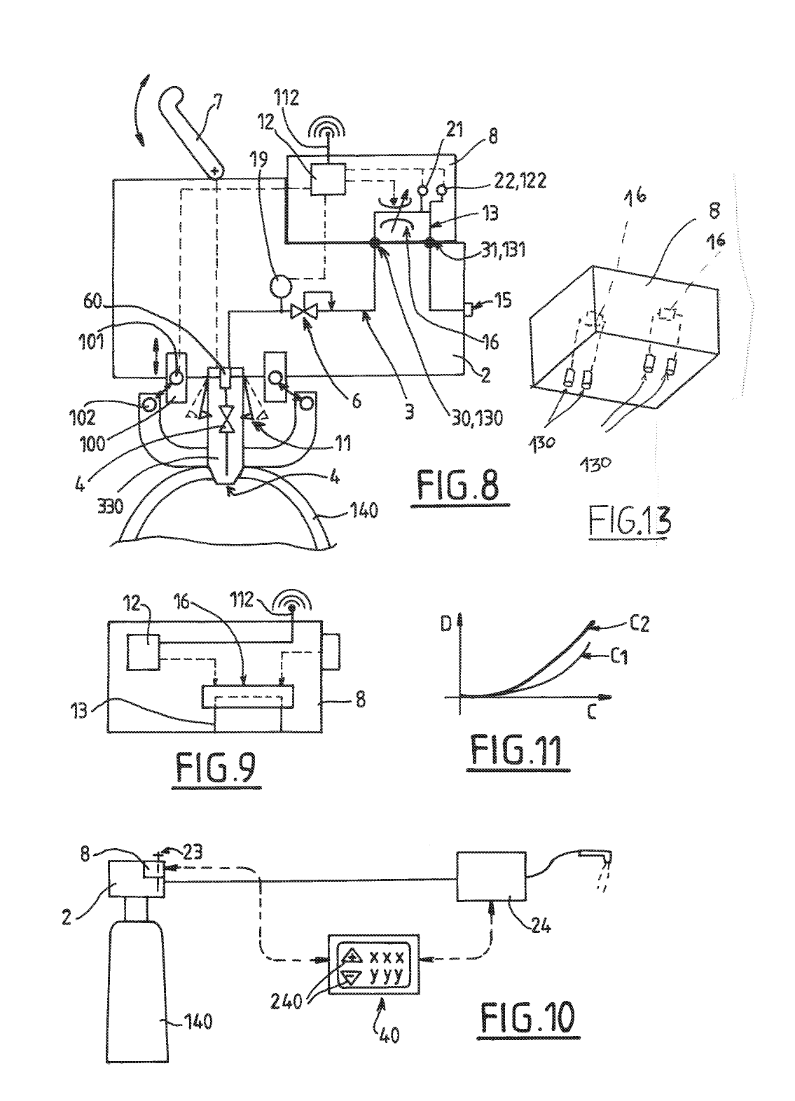

The valve 1 illustrated in the figures includes a body 2 accommodating a fluid circuit 3, 13. The fluid circuit 3, 13 has an upstream end 4 that is intended to be connected to a reserve of pressurized fluid (for example a bottle 140 of a set of pressurized gas bottles, cf. FIG. 8 or 10). The circuit 3, 13 has a downstream end 5, 150 that is intended to be connected to a device receiving the fluid, for example a welding or other device 24 (cf. FIG. 10).

The circuit 3, 13 conventionally includes at least one unit 6, 60 for monitoring the flow rate in the circuit 3, 13.

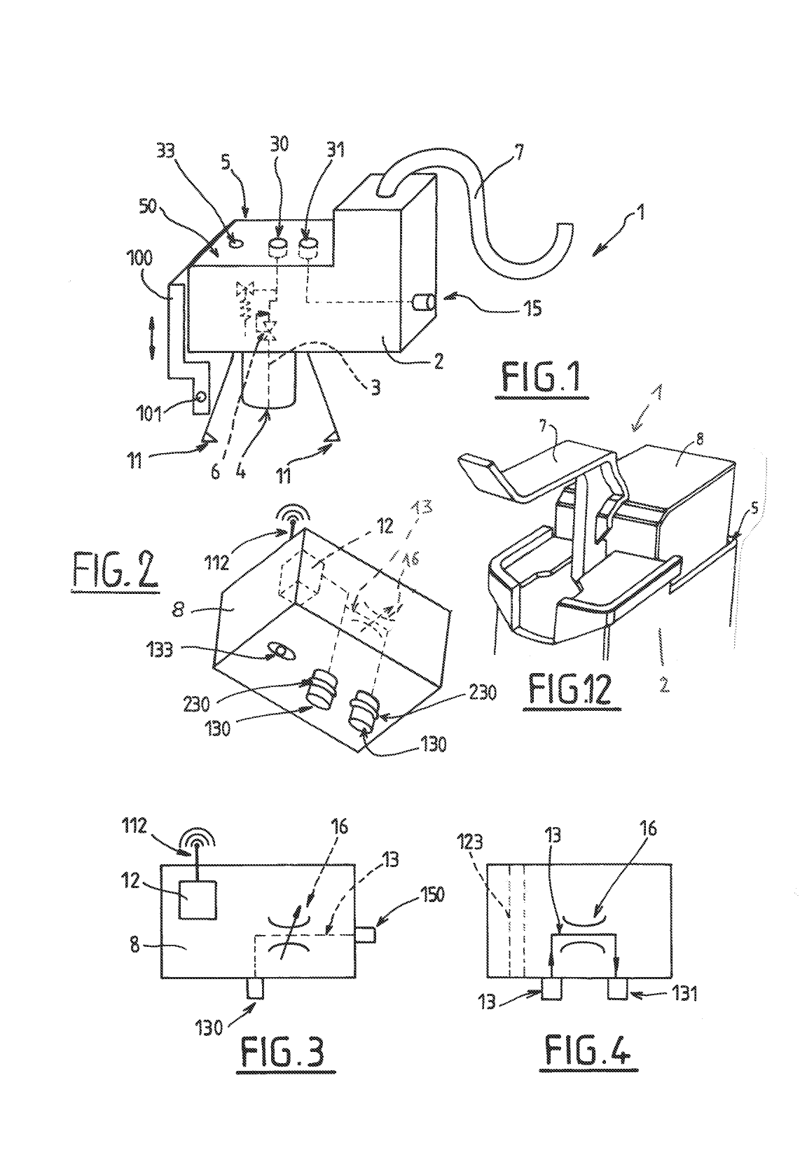

In the example from FIG. 1, the portion of the circuit 3 situated in the body 2 of the valve 1 includes a pressure-reducing valve 6 for reducing the pressure to a particular fixed or variable value.

The valve 1 further includes an actuator member 7 for controlling at least one flow rate monitoring unit (for example the pressure-reducing valve or an isolating valve or a valve pusher).

In the example from FIG. 1, the actuator member 7 is a pivoting lever. Of course, instead or in addition to this, the actuator member could include a part that is mobile in translation, a knob that can be turned or a button (cf. for example FIGS. 5 to 7).

The valve 1 includes in particular an adjustable flow rate regulator 16 that is preferably controlled by a data acquisition and processing electronic unit 12 integrated into the valve 1. The data acquisition and processing electronic unit 12 includes for example at least one programmable microprocessor associated with a memory.

The data acquisition and processing electronic unit 12 includes or is connected to an antenna 112 configured to receive a remote control signal from the flow rate regulator 16 for remote monitoring and modification of the flow rate imposed by the latter. In addition to or instead of this, the data acquisition and processing electronic unit 12 could include a wired connection port or a port for any other communication device.

In the example from FIGS. 1 to 7 in particular, the flow rate regulator 16 is integrated into a regulator module or unit 8 removably mounted on the body 2 of the valve. Of course, this flow rate regulator 16 could instead be integrated into the body 2 of the valve 1.

According to one advantageous particular feature, the device and notably the valve 1 may include a unit 101, 102 for determining the nature of the fluid in the circuit 3 connected to the data acquisition and processing electronic unit 12. That electronic unit 12 may be configured to adapt how the flow rate regulator 16 is controlled, preferably automatically as a function of the nature of the fluid, that is to say to adjust or to calibrate the flow rate regulator 16 as a function of said nature of the fluid from at least one predetermined nature and/or a plurality of predetermined natures.

For example, for the same flow rate setpoints, the more the gas mixture contains a gas having a high viscosity and/or large molecules, the larger the orifice will be. Conversely, the more the gas mixture contains gas having a low viscosity and/or small molecules, the relatively smaller the orifice will be.

The flow rate regulator 16 includes for example a mechanism for modifying the size of at least one passage for the fluid to modify its flow rate. The data acquisition and processing electronic unit 12 may be configured to store or to receive calibration data, notably calibration curves, or an adaptive algorithm defining respective sizes of the at least one passage as a function of the nature and/or the composition of the fluid from a plurality of natures and/or compositions passing through the flow rate regulator 16 to obtain a particular flow rate.

For example, as illustrated in FIG. 11, the flow rate regulator 16 may be controlled electronically by a setpoint signal C (for example an electrical voltage in volts) that defines an orifice adjustment size producing a flow rate D (for example in liters per minute).

Depending on the nature of the gas or gas mixture determined from among a plurality of possibilities (for example from among: argon, oxygen, helium, carbon dioxide, hydrogen, etc.), the same orifice size can generate flow rate differences. Accordingly, as shown diagrammatically in FIG. 11, the same setpoint signal applied to two different gases can generate slightly different flow rate curves C1, C2.

The above method corrects this difference, and the device enables more accurate regulation of the gas flow rate.

The unit for determining the nature of the fluid may include a wireless scanning (and possibly writing) electronic device 101 such as a wireless communication scanner or transponder configured to scan remotely and wirelessly (and possibly to write) information stored by a data storage electronic device 102 such as a wireless communication RF tag attached to a fluid source (cf. FIG. 8).

These data media 101, 102 may include a passive transponder with no device for generating electromagnetic waves, an active transponder including a device for generating electromagnetic waves, the transponder including a data read only or data read/(re)write electronic memory, with or without a battery.

That is to say that information (nature of the gas, bottle reference numbers, etc.) can be transmitted wirelessly between the bottle 140 or the set of the bottles and the valve 1 and then the module 8 via the transponders 102, 101.

Moreover, as illustrated in FIGS. 1 and 8, the communication electronic device may be accommodated in a mobile support 100.

The gas is preferably identified by near field communication (NFC). Of course, other technologies with the same range or different ranges may be envisaged (“RFID”, “Bluetooth”, “WIFI”, “LoRA”, “SigFox”, infrared, barcode, flash code, etc.).

Accordingly, the information medium 102 storing the identification of the type of gas may be situated on the bottle 140 or the set of bottles (rack), for example directly on the bottle and/or on a basic valve 330 mounted on the bottle and/or on a cap or protection frame or any other appropriate element of the device. Similarly, this gas identification information may be provided remotely, for example by radio, for example by remote control and/or a local or remote interface (see below with reference to FIG. 10).

The flow rate regulator 16 may include for example a variable orifice mechanism of piezoelectric type or a variable orifice mechanism using a mobile slide valve, or any other appropriate system.

In the case of an electrically controlled piezoelectric type flow rate regulator 16, the setpoint may be expressed by the data acquisition and processing electronic unit 12 (notably via a processor) after the type of gas has been determined (or determined by default). This control setpoint may be converted into a voltage (in volts for example). The piezoelectric flow rate regulator 16 is then able to adjust the deformation of a leaf spring to adjust an orifice and therefore the flow rate between an inlet and an outlet.

If the flow rate regulator 16 uses a mechanism with a mobile slide valve moved by a motor, the setpoint may be expressed in terms of distinct positions of a shaft or a mobile part driven by the motor. The motor may for example adjust the position of the slide valve to open to a greater or lesser degree a passage for the gas between an inlet and an outlet.

As shown in FIG. 8, the valve 1 may include at least one pressure (or other) sensor 19, 20, 21, 122 configured to measure at least the pressure in the circuit 3.

At least one sensor 19 may be connected to an electrical connector 33 opening onto the body 2 in the housing 5, for example adjacent to the orifices 30, 31.

For example, the device may include at least:
a pressure sensor 19 configured to measure the pressure in the circuit 3 on the upstream side of the flow rate regulator 16, and notably on the upstream side of the pressure-reducing valve 6 situated in the circuit 3,
a pressure sensor 20 configured to measure the pressure in the circuit 3 on the upstream side of the flow rate regulator 16 and on the downstream side of the pressure-relief valve 6 situated in the circuit 3,
a pressure sensor 21 configured to measure the pressure in the circuit 3 on the downstream side of the flow rate regulator 16,
at least one sensor 122 of the temperature in the circuit,
a flow rate sensor on the downstream side of the flow rate regulator 16.

By flow rate sensor is meant either a sensor measuring the flow rate directly (flow meter) or a calculation algorithm measuring the flow rate on the basis of pressure values on the upstream and downstream sides of a (possibly temperature-corrected) pressure-reducing valve or variable orifice.

The data acquisition and processing electronic unit 12 of the valve 1 may notably be configured to determine or to calculate the real value of the fluid flow rate in the circuit 3 on the basis of information from the aforementioned at least one sensor (for example via a simple state equation).

For example, the data acquisition and processing electronic unit 12 may be configured to receive the measurements from at least one temperature sensor 22 in the circuit 3, 13 and to calculate the flow rate of fluid in the circuit as a function of the temperature measurement, the pressure measurement and the configuration of the flow rate regulator 16.

As symbolically represented in FIG. 10, the device may include a handheld data acquisition, storage and processing device 40 such as a remote control including a wireless communication device and at least one display. This device 40 may notably be configured to exchange data with the data acquisition and processing electronic unit 12 of the valve 1 to monitor, display and control remotely information, notably the flow rate imposed by the flow rate regulator.

This wireless communication may use at least one of the communication technologies mentioned above.

The electronic device 40 preferably includes a human-machine interface configured to display tactile control symbols 240 for modifying the flow rate value imposed by the flow rate regulator 16. This device may also display the actual (measured or calculated) flow rate and a gas flow rate recommended on the basis of parameters entered by the user or detected by the device.

When the acquisition electronic unit 12 is accommodated in the removable regulator module 8, to transmit data from sensor(s) 19 between the body 2 and the module 8, the regulator module 8 may have on its lower surface at least one electrical connector 133 connected to the data acquisition and processing electronic unit 12. The body 2 includes at least one conjugate electrical connector 33. These electrical connectors 33, 133 are configured to cooperate and to transmit information when the regulator module 8 is mounted in position on the body 2.

In the embodiment with a removable regulator module 8, a part of the circuit 3 is for example housed in the body 2 of the valve and has a first end opening onto the body 2 at the level of a first orifice 30. A fluid circuit 13 portion is situated in the regulator module 8 and has an upstream end including a first fluidic connector 130 configured to be connected in fluid-tight manner at the level of the first orifice 30 when the module 8 is mounted in position on the body 2. The flow rate regulator 16 therefore regulates the flow rate or fluid in the circuit 3, 13 on the upstream side of the downstream end 15.

The first fluidic connector 130 of the regulator module 8 and the first orifice 30 of the body 2 form a male-female fluidic connection system including a sealing system 230 such as an O-ring for example. The first fluidic connector 130 is of the male type and projects on the regulator module 8 and includes a seal 230 such as an O-ring, for example.

The fluid circuit 3 situated in the body 2 may include a first portion extending between the upstream end 4 and the first orifice 30 and a second portion extending between a second orifice 31 opening onto the body 2 and an outlet downstream end 15 fitted for example with a connector.

In the example from FIGS. 2, 4 and 5 to 9, the circuit 13 portion situated in the regulator module 8 has a downstream end including a second fluidic connector 131 configured to be connected in fluid-tight manner at the level of the second orifice 31 when the regulator module 8 is in position mounted on the body 2. That is to say that when the regulator module 8 is mounted in position on the body 2, the circuit 13 portion of the regulator module 8 therefore provides a fluidic connection between the first portion and the second portion of the circuit 3 of the body 2. That is to say that the gas passes through the regulator module 8 (via the flow rate regulator 16) before returning to the body 2.

In this case, the gas the flow rate of which has been regulated exits at the level of an end 15 of the body 2.

As for the first connector 130, the second fluidic connector 131 of the regulator module 8 and the second orifice 31 of the body 2 form a male-female fluidic connection system including a sealing system 230 such as an O-ring (for example of the same type as for the first connector 130).

This provides a reliable mechanical and fluidic connection between these two entities 2, 8.

As shown, the body 2 of the valve 1 preferably includes a housing 5 intended to receive the regulator module 8. The housing 5 includes a bottom 50 that is substantially horizontal when the valve 1 is in the vertical position of use. The bottom 50 is intended to receive the base (lower face) of the regulator module 8 when the regulator module 8 is in position mounted on the body 2. As shown, the first orifice 30 and the second orifice 31 preferably discharge at the level of said bottom 50 of the housing 5.

The two connectors 130, 131 of the regulator module are therefore situated on the lower face of the latter.

This arrangement improves the strength and the protection of the fluidic connections and contributes to the correct positioning and retention of the module 8 on the body 2.

The regulator module 8 is retained on the body 2 by clips and/or by removable retaining members such as a system of nuts and bolts or tapped holes (cf. for example references 123, 23 in FIGS. 4 and 10).

As illustrated in FIG. 3, the regulator module 8 may include a single inlet connector 130 intended to cooperate with the first orifice 30 and an outlet connector 150 situated on the module 8. That is to say that the fluid coming from the first orifice 30 does not reenter the body 2 of the valve.

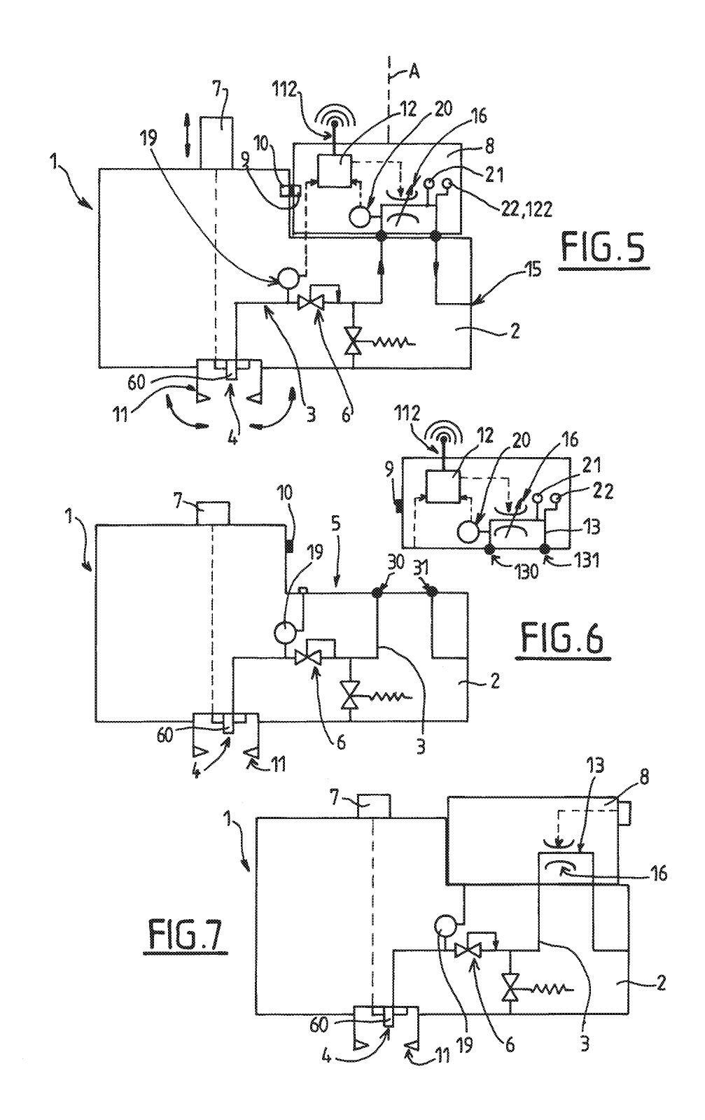

As mentioned above and illustrated in FIGS. 1 and 8, the valve 1 may include at least one first functional electronic unit 101 intended to exchange data with the electronic unit 12 of the regulator module 8. To this end, the body 2 of the valve may include a device 10 with contact(s) situated in the housing 5, intended to cooperate with a conduit set of electrical contact(s) 9 situated on the regulator module 8 when the latter is in position mounted on the body 2 of the valve (cf. FIGS. 5 and 6 which show these electrical contacts diagrammatically).

For example, the regulator module 8 is mobile in translation in a first direction A (cf. FIG. 5) relative to the housing 5 between a mounted position and a position demounted from the body 2. The contact(s) device 10 is preferably disposed on a wall of the housing situated in a plane parallel to said first direction A. Thus, the contact between the contact(s) device 10 and the conjugate set of electrical contact(s) 9 occurs in a plane parallel to the first direction A.

In this way, when the module 8 is correctly mounted on the body 2 of the valve 1 a physical electrical connection is established enabling the transmission of data or of energy for example.

Of course, as mentioned above, the flow rate regulator 16 could be integrated into the body 2 (rather than housed in a removable module 8).

Similarly, the valve 1 is not limited to the embodiment from FIG. 1. For example, as illustrated in FIGS. 5 to 8, as well as (or instead of) the pressure-reducing valve 6, the valve may include a mobile valve pusher 60 that can be actuated to command the opening of a valve 4 of another valve 330 or of a device to which the valve 1 is connected. This valve pusher 60 may be actuated by the actuator member 7.

As illustrated in FIGS. 1 to 5 and notably in FIG. 8, the valve 1 may include a mounting end including mobile attachment members 11 intended to cooperate with complementary attachment members to form a system for rapid connection of the valve 1 to another valve 330 or to a fluid circuit. The valve 1 may include a support part 100 mobile on the body forming a member for actuating the mobile attachment members 11 such as a member for locking and/or unlocking the mobile attachment members 11.

This mobile support part 100 may be the support of a transponder or RF tag 101 described above (cf. FIG. 1).

The actuator member 7 (in this nonlimiting example a lever) may be mobile between a first position which it does not hinder the movement of the regulator module 8 relative to the body 2 of the valve 1 (lever in bottom position for example) and a second position in which the actuator member 7 forms a mechanical abutment preventing movement of the regulator module 8 relative to the body 2 to prevent demounting it from the body 2 (lever in top position for example, cf. FIG. 12).

For example, the actuator member 7 has a shape adapted to nest with or immobilize the exterior shape of the regulator module 8. This makes it possible for example to prevent unintended disconnection of this module 8 when the valve is under pressure (position of the actuator member 7 allowing for example the pressurization of a part of the fluid circuit 3).

As illustrated diagrammatically in FIG. 13, the module 8 may include two (or more) distinct sets of fluidic connector(s) 130 connected to respective flow rate monitoring units 16 (for example flow rate regulators, pressure-reducing valves, etc.) enabling a plurality of configurations of use of the module 8 depending on whether the module 8 is connected to the valve via one or the other of the sets of connectors 130. Thus, for example, depending on whether the module 8 is connected to the valve in one direction or in another direction (via one or the other of the sets of connectors 130), the gas flow rate is for example regulated to different particular levels.

For example each set of connector(s) 130 is associated with a different regulator unit 16 (calibrated orifice of different sections for example). For example, the sets of connector(s) 130 are disposed symmetrically relative to the center of the lower face of the module 8.

The operative is therefore able to choose a monitoring unit 16 by using the associated connectors 130 (the respective positions may be associated with markings on the module 8).

Just like the module from FIG. 7, this module 8 may notably be a purely mechanical “standby” module intended to replace the remote controlled module should it fail for example.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-15. (canceled)

16. A fluid supply device including a pressurized fluid valve, comprising a body, a fluid circuit accommodated at least in part in the body, the fluid circuit having an upstream end configured to be connected to a reserve of pressurized fluid and a downstream end configured to be connected to a receiving device, the fluid circuit including at least one member for controlling the flow rate in the fluid circuit and a member for actuating the fluid circuit, the at least one control member including an adjustable flow rate regulator, controlled by a data acquisition and processing electronic unit integrated into the valve and including an antenna or a wired connection configured to receive a remote control signal from the flow rate regulator to monitor and to control remotely the flow rate imposed by the flow rate regulator, comprising a unit for determining the nature of the fluid in the fluid circuit connected to the data acquisition and processing electronic unit, the electronic unit being configured to adapt how the flow rate regulator is controlled as a function of the nature of the fluid.

17. The device as claimed in claim 16, wherein the flow rate regulator comprises a mechanism for modifying the size of at least one passage for the fluid to modify its flow rate, the data acquisition and processing electronic unit being configured to store and/or to receive a set of calibration data.

18. The device as claimed in claim 17, wherein the data acquisition and processing electronic unit is configured to store and/or to receive a set of calibration data including: curves or equations defining respective sizes of the at least one passage as a function of the nature of the fluid in the flow rate regulator to obtain a particular flow rate.

19. The device as claimed in claim 16, wherein the unit for determining the nature of the fluid includes a wireless scanning electronic device such as a transponder configured for wireless remote scanning of information stored by a data storage electronic device such as a wireless communication RF tag attached to a fluid source.

20. The device as claimed in claim 16, wherein the data acquisition and processing electronic unit is configured to adjust to calibrate the flow rate regulator by modifying the size of a passage orifice for the fluid and in that, for a particular flow rate setpoint, the electronic unit is configured to modify the size of the orifice according to the nature of the fluid from among a plurality of distinct natures, the nature of the fluid comprising at least one of: the viscosity of the fluid, the size of the molecules of the fluid, the composition of the fluid or of the mixture of fluids.

21. The device as claimed in claim 16, further comprising at least one of the following: a pressure sensor configured to measure the pressure in the fluid circuit on the upstream side of the flow rate regulator, a pressure sensor configured to measure the pressure in the fluid circuit on the downstream side of the flow rate regulator, a sensor of the temperature in the fluid circuit, a flow rate sensor, the data acquisition and processing electronic unit of the valve being configured to determine or to calculate the value of the fluid flow rate in the fluid circuit on the basis of the information from the aforementioned at least one sensor.

22. The device as claimed in claim 16, further comprising a hand portable data acquisition, storage and processing electronic device such as a remote control including a wireless communication device and at least one display, said device being configured to exchange data with the data acquisition and processing electronic unit of the valve remotely to monitor, display and control information, notably the flow rate imposed by the flow rate regulator.

23. The device as claimed in claim 22, wherein the electronic device includes a human-machine interface configured to display tactile control symbols for modifying the flow rate value imposed by the flow rate regulator.

24. The device as claimed in claim 22, wherein the valve comprises a pressure-reducing valve situated in the fluid circuit on the upstream side of the flow rate regulator and configured to reduce the pressure of the fluid to a particular fixed or variable value, the valve including at least one pressure sensor configured to measure the pressure in the fluid circuit on the upstream side of the flow rate regulator on the upstream and/or downstream side of the pressure-reducing valve, the data acquisition and processing electronic unit being configured to receive the measurements from the at least one pressure sensor and automatically to adjust accordingly the flow rate imposed by the flow rate regulator as a function of any fluctuation of the measured pressure.

25. The device as claimed in claim 24, wherein the data acquisition and processing electronic device is configured to receive the measurements from at least one temperature sensor in the fluid circuit and to calculate the fluid flow rate in the fluid circuit as a function of the temperature measurement, the pressure measurement and the configuration of the flow rate regulator using a gas state equation such as a perfect gas state equation.

26. The device as claimed in claim 22, wherein the data acquisition and processing electronic unit is configured to receive the measurements from at least one flow rate sensor in the fluid circuit on the downstream side of the flow rate regulator and in that the data acquisition and processing electronic unit is configured, in response, to carry out at least one of the following: sending the measured flow rate value to the portable data acquisition, storage and processing electronic device in order to display it, automatically adjusting the flow rate imposed by the flow rate regulator as a function of any difference between the measured flow rate and the imposed flow rate.

27. The device as claimed in claim 16, wherein the flow rate regulator includes a variable orifice mechanism of piezoelectric type and/or of rotary or sliding valve type.

28. The device as claimed in claim 16, wherein the upstream end of the body of the valve is fluidically connected to a tank or to a set of tanks of pressurized gas including a data storage electronic device that can be interrogated remotely such as a wireless communication RF tag, the data storage electronic device storing information defining the nature of the gas in the tank or tanks, the fluid supply device including an electronic device for remotely scanning information stored in the data storage electronic device configured to transfer said information to the data acquisition and processing electronic unit integrated into the valve.

29. The device as claimed in claim 16, wherein the flow rate regulator is accommodated in a regulator module removably mounted in a housing formed on the body of the valve.

30. The device as claimed in claim 29, wherein the valve includes at least one first functional electronic unit configured to exchange data with an electronic unit of the regulator module, the body of the valve including a device with contact(s) situated in the housing intended to cooperate with a conjugate set of electrical contact(s) situated on the regulator module when the latter is in the position mounted on the body of the valve.
